(19) United States
(12) Patent Application Publication
(10) Pub. No.: US 2008/0073169 A1
(43) Pub. Date: Mar. 27, 2008

(54) INDEXING DRIVE DEVICE AND METHOD FOR PERIODIC STOPPING AND STARTING OF A ROTATING OUTPUT

(76) Inventor: Michael C. Walters, Jonesboro, AR (US)

Correspondence Address: CRUTSINGER & BOOTH, 1601 ELM STREET, SUITE 1950, DALLAS, TX, 752014744, US

(21) Appl. No.: 11/862,517

(22) Filed: Sep. 27, 2007

Related U.S. Application Data
(60) Provisional application No. 60/856,094, filed on Nov. 2, 2006.
(60) Provisional application No. 60/847,585, filed on Sep. 27, 2006.

(51) Int. Cl. F16D 13/52; G05B 19/18; G09F 11/02

(52) U.S. Cl. 192/70.2; 40/503; 700/61

(57) ABSTRACT

An indexing drive device for periodic stopping and starting of a rotating output is provided, which includes: (a) a driven cog, wherein the driven cog comprises: (i) a plurality of outer surfaces equally spaced around a periphery of the driven cog; and (ii) a plurality of driven lobes equally spaced around the driven cog; (b) a driving cog adapted to be cooperatively positioned to engage with the driven cog, wherein the driving cog comprises: (i) at least two driving lobes, whereby the driving lobes on the driving cog engage the driven lobes of the driven cog during a turning cycle of the driven cog; and (ii) a semi-circular disc that mates with one of the outer surfaces during a dwell cycle of the driven cog that holds the driven cog in a fixed position during the dwell cycle, wherein the disc has a blank section in the region of the driving lobes to allow the driven cog to turn during a turning cycle of the driven cog. A sign assembly have a plurality of multi-faced louvers is also provided, including a means for periodic stopping and starting of a rotating output.

### CROSS-REFERENCE TO RELATED APPLICATIONS

This application claims the priority of U.S. provisional patent application Ser. No. 60/856,094 filed Nov. 2, 2006 and U.S. provisional patent application Ser. No. 60/847,585, filed Sep. 27, 2006.

### STATEMENT REGARDING FEDERALLY SPONSORED RESEARCH OR DEVELOPMENT

Not applicable

### REFERENCE TO MICROFICHE APPENDIX

Not applicable

### TECHNICAL FIELD

The invention generally relates to indexing devices for periodic stopping and starting of a rotating output. According to a particularly advantageous application of the invention, it relates to mechanical advertising displays, and more particularly, to signs and billboards that use multi-faced louvers to enable multiple sign displays, usually three, to be periodically or selectively shown on a single structure.

### BACKGROUND

Advertising signs are a widely used means of passing on advertising messages to the general public. Of particular success are sign displays that use a plurality of sign elements in the general shape of triangular prisms to enable three billboard type displays to be periodically or sequentially shown on a single structure.

The triangular prism segments, referred to in the art by various names such as “display elements” or “louvers,” are adapted for rotation about parallel axes, whereby predetermined ones of the plurality of faces of each display element can be aligned in co-planar relationship to produce a substantially complete image. By this means, for example, three different signs can be displayed by rotation of the triangular display elements and alignment of the display surfaces. In addition, the rotation of the display elements helps attract attention to the sign or billboard.

Typical mechanical signs, however, have experienced many problems. For example, the synchronization of the louvers must be maintained, or the displays will be disrupted. The mechanical interlocking of the louvers has posed reliability and maintenance difficulties and high costs. When the signs are used outdoors, weather conditions also become a major factor in the reliability and maintenance. The larger the size of the sign magnifies these problems. Over the years, many designs have been tried to improve the reliability and reduce maintenance costs associated with this kind of sign, however, problems with reliability and maintenance have continued to plague the industry.

U.S. Pat. No. 1,256,645 entitled “Advertising Machine” issued Feb. 19, 1918 having for named inventor John B. Barnett discloses an advertising machine in which each shaft for the three-faced slabs is provided with projecting arms which form in effect a multilateral gear wheel. A drive shaft may be driven by any suitable power, as by an electric motor. The drive shaft is provided with mutilated gear-wheels. The gear-wheels drive the mutilated gear-wheels of the advertising slabs and thus rotate the shafts of the advertising slabs. Three-sided holding blocks are mounted on the shafts of the advertising slabs and bear against a spring-controlled bar which is slidingly mounted in brackets which support the bar.

U.S. Pat. No. 1,461,047 entitled “Advertising Sign” issued Jul. 10, 1923 having for named inventor Joseph L. Ray discloses an advertising sign having a permanent frame supported on suitable standards. In the supporting standards for the frame, or in any other desired relation thereto, is supported a rotatable shaft on which may be keyed a series of gear wheels on each of which is bolted a gear segment. The segment may be carried by a bolt adapted to be moved adjustably in a segmental slot cut in each of the wheels. The shaft is geared operatively to a prime mover by which rotation is imparted to each of the gear wheels.

U.S. Pat. No. 3,304,638 entitled “Activated Changeable Advertising Sign” issued Feb. 21, 1967 having for named inventors William A. Grandell, James M. Wasson, and Richard Z. Wasson discloses a sign with a plurality of hub members operatively mounted on the lower shafts of triangularly faced sign-bearing units, each of the hub members having a plurality of radial studs mounted in different vertical planes, and a plurality of driving sprockets mounted in transversely spaced apart relation on a driven shaft, each of the sprockets having a plurality of radial arms of varying lengths thereon, each one of the arms being adapted to engage only one of the studs, whereby obstructed stoppage of rotation of any one or more the sign units will cause one of the arms to upwardly elevate the obstructed sign unit into upper non-operative position wherein the studs connect to the obstructed unit will not be contacted by the arms of the adjacent sprocket.

U.S. Pat. No. 3,307,170 entitled “Multi-Face Indicator System” issued Feb. 28, 1967 having for named inventors Tetsuo Aoyama, et al. discloses a multi-face indicator having a number of indicating faces of different color, any one of which may be moved selectively to one indicating position. With each indicator having more than one indicating face, each of a different color, the different faces can be combined with other such indicators to form a numeral, letter, symbol or other pattern. But the highly complex inter-workings to regulate the turning of particular triangle portions of each indicator and the many moving parts increased the possibility of breakdown and the difficulty of repair.

U.S. Pat. No. 3,387,394 entitled “Sign Construction” issued Jun. 11, 1968 having for named inventor Willy T. Werner discloses a display sign of the type in which three different advertising messages are presented in sequence by rotation of a plurality of three-sided louvers. Panels are secured to core members to make up the louvers by means of brackets and clips which secure these members together upon relative movement in one direction. A lock between the core members and panels prevents movement in a direction permitting disengagement. A spring biased pin carried by the louvers snaps into engagement with a frame to rotatably support the upper end of the louvers.

U.S. Pat. No. 4,021,946 entitled “Multielement Changeable Sign Display” issued May 10, 1977 having for named inventor James T. Bradshaw discloses a sign display comprising a plurality of triangular display elements each having three display surfaces. The display elements are arranged along mutually perpendicular sets of axes to define a matrix display having a display pane. Rotary drive shafts extend through the display elements parallel to the display surfaces, and each display element includes a clutch structure comprising frustoconical clutch members received in frustoconical apertures formed in the display element and spring biased to be normally coupled to the display element for rotation with the drive shaft extending therethrough. Abutment surfaces corresponding to the display surfaces project from the lower end of each display element for selective actuation to terminate rotation of the display element with a predetermined display surface situated in the display pane. The first display surfaces of all of the display elements may be utilized in combination to form a dedicated sign, and the second and third display surfaces of each display element may comprise contrasting colors, in which case the second and third surfaces of the display elements are utilized to form a desired sign by means of a matrix display.

U.S. Pat. No. 4,189,859 entitled “Device at Display Arrangement” issued Feb. 26, 1980 having for named inventor Stig B. Ahlgren discloses a display having a frame and prisms rotatably mounted therein, each of the prisms including adjacent longitudinally extending side surfaces so that each set of associated side surfaces of the prisms provides a display when rotated to a side-by-side position defining a permanently recurring sequence with the number of displays corresponding to the number of side surfaces on each prism. Each prism is provided with a pair of rotation axles disposed at opposite ends thereof. A drive motor and a transmission rotate the prisms synchronously, the drive motor being connected to one of the rotation axles. Gear discs are mounted on one rotation axle of each pair provided on the prisms with at least one belt mounted on the gear discs for rotating the gear discs and the prisms when one rotation axle is output by the drive motor, the belt being toothed for meshing with the gear disks. U.S. Pat. No. 4,189,589 is incorporated herein by reference in its entirety.

U.S. Pat. No. 4,638,580 entitled “Publicity Board with Rotating Prismatic Members,” issued Jan. 27, 1987 having named inventors Anna Giannetti, Sergio Massa, and Cesare Re that discloses a publicity board provided with a plurality of rotatable prismatic members mounted side-by-side, each being arranged to carry portions of publicity images on its faces, and further provided with a meter for rotating the prismatic members about their respective longitudinal axes. The motor is coupled to the prismatic members by means of an operating shaft driven by the motor and carrying a plurality of radial rods such that they rotate, to each cooperate with respective appendices extending radially from an end pivot of each prismatic member, for the purpose of transmitting to this latter a rotation through an angle which is double the angle formed at the center by each face of said prismatic member.

U.S. Pat. No. 5,161,421 entitled “Driving device for driving or operating elongate display members at signs for consecutive, repeated presentation of series of images” issued Nov. 10, 1992 having named inventor Stig E. A. Stigsson that discloses a driving device for driving or operating elongate display members at signs for consecutive, repeated presentation of series of images, whereby said elongate display members are driven through pairs of gear wheels having conical teeth and whereby a driving gear wheel in each pair of gear wheels is provided on a drive shaft and a driven gear wheel in each pair is operatively connected with the elongate display member to be driven. In this driving device, for being able to rotate the driving unit forming part thereof continuously in one and same direction of rotation and to ensure that the elongate display members can not come “out of phase” neither during rotation nor when they stand still in their display positions, the driving gear wheel comprises a gear sector which occupies only a part of the periphery of said driving gear wheel such that said driving gear wheel, is in driving engagement with the driven gear wheel only during a part of a revolution of said driving gear wheel and the drive shaft has a lock which is provided to cooperate with said driven gear wheel or with members non-rotatably connected therewith in such a manner that said driven gear wheel is blocked against rotation during that part of the revolution of said driving gear wheel when the gear sector of said driving gear wheel is out of driving engagement with the teeth of said driven gear wheel.

U.S. Pat. No. 5,255,463 entitled “Rotating Sign Assembly” issued Oct. 26, 1993 having for named inventor Paul H. Werner discloses a rotating sign assembly including a number of multi-sided, rotatable sign segments output by an elongated drive shaft operably interconnected with each of the sign segments. The drive shaft includes at least one multi-armed output cam fitted to the drive shaft. Each arm of the output cam includes an outer sloped driving surface and a peaked extremity. The output cam is rotatably output by a driving arm assembly comprising a driving pin plate and an output arm stop plate. The driving pin plate includes a pair of pins, one situated on each end of the plate. Each driving pin alternatingly interacts with the outer sloped surfaces of the cam for rotation thereof, this rotation being halted by interaction of the peaked extremities alternatingly with the ends of the stop plate.

U.S. Pat. No. 5,255,465 entitled “Multiple Display Sign Assembly” issued Oct. 26, 1993 having for named inventor Hector Perez discloses a multi-display sign assembly including a frame structure having a pair of support bars, and a plurality of elongated, lightweight triangular members rotatably held between the support bars by axle bars which extend longitudinally through the triangular members and protrude through the support bars. A motor is connected to a reducer which regulates the RPM's of a drive gear connected thereto, the drive gear including teeth only along 120 degrees of its exterior surface such that, when the teeth engage a secondary gear which is connected to the axle bar of one of the triangle members, that triangle member will rotate resulting in a new display face of all the triangle members rotating to form a new one of three distinct display surfaces containing advertising or like indicia thereon. U.S. Pat. No. 5,255,465 is incorporated herein by reference in its entirety.

U.S. Pat. No. 5,511,330 entitled “Louver Sign Transmission System” issued Apr. 30, 1996 having for named inventor Dale I. Havens discloses a transmission system for louver type signs wherein the signs consist of a plurality of multiple faced louvers having indicia defined thereon, and the side-by-side relationship of the louvers permits pre-selected faces to define a completed image and simultaneous partial rotation of the louvers presents a new visible image, and wherein each louver is operated by a separate “T” drive bevel gear transmission having an output shaft upon which a louver is mounted operatively connected to a drive shaft perpendicularly related to the output shaft. The drive shafts of adjacent transmissions are interconnected, and a plurality of transmissions are simultaneously operated by a single motor drive source. U.S. Pat. No. 5,511,330 is incorporated herein by reference in its entirety.

U.S. Pat. No. 5,806,221 entitled “Drive For A Multi-Sided Display Sign” issued Sep. 15, 1998 having for named inventor Loren L. Vander Woude discloses a segmented sign drive that provides rotational driving force from a drive arm moving in reciprocating motion. The arm moves a series of pins in a series of grooves located in drive disks. A drive disk is mounted to each segment of the sign so as to rotate the segments into preferred positions in a step-by-step sequence where all of the segments move together to new positions so as to change the outward appearance of the sign. The grooves are ramped so that, on a forward stroke of the drive arm, the pins are moved upward on a ramped groove in the drive disks to fall into a preferred hole at one end of each of the grooves. On the return or reverse stroke, the pins, now caught within the holes, cause the disks to rotate by one part of the cycle. On the next cycle, the pins again move out of the holes and up the ramp surfaces of the next grooves which have been moved into place where the former grooves were. In this manner, the disks are caused to rotate by an appropriate amount on each rotational cycle of a switch limited motor. U.S. Pat. No. 5,806,221 is incorporated herein by reference in its entirety.

U.S. Pat. No. 6,038,799 entitled “Indexing System For Changeable Signs” issued Mar. 21, 2003 having for named inventors Dale I. Havens and Michael R. Atkinson discloses an indexing system for signs consisting of a plurality of indicia bearing vane faces wherein the vane faces are sequentially exposed to view in the manner of a “wave”, such sequential revealing of the sign vane faces generating interest in the sign's message. Each sign vane is rotated by a transmission, and the transmissions are interconnected in such a manner as to sequentially operate the vanes to produce the “wave” action and detents associated with each transmission lock the sign vane in the desired position. U.S. Pat. No. 6,038,799 is incorporated herein by reference in its entirety.

U.S. Pat. No. 6,065,232 entitled “Multiple Display System” issued May 23, 2000 having for named inventors Charles S. Haughey et al. discloses an apparatus for controlling a drive mechanism of a panel display system that includes a rotary member attached to a drive assembly, the rotary member having indicators located at known intervals that are detected to ensure that the drive assembly starts and stops at precise locations. In a preferred embodiment, the control system is applied to a panel display system that displays different scenes using an array of elongated three-sided display elements. The preferred control system includes an aluminum disk that is attached to rotate in connection with rotation of the drive assembly.

U.S. Pat. No. 6,128,841 entitled “Drive Mechanism for Picturn Sign” issued Oct. 10, 2000 having for named inventor Paul H. Werner discloses a rotating sign assembly having a plurality of rotatable, multi-sided, sign segments and a drive mechanism for rotatably driving the sign segments. The drive mechanism includes a drive shaft and one or more output shafts that each operate to rotate a multi-sided sign segment. A cam is fitted to each of the output shafts so that rotation of the cam causes rotation of the corresponding output shaft and sign segment. The cam has an outer perimeter and multiple equally spaced engagement slots which extend radially inwardly from the outer perimeter. Outwardly facing stabilizing portions are positioned between each of the engagement slots. The cam has multiple dwell positions, each corresponding to the display of one side of the multi-sided sign segment operated by the corresponding output shaft. A cam driver assembly is fitted to the drive shaft so that it rotates with the drive shaft. The cam driver assembly has a cam driver which extends outwardly from the axis of rotation and terminates in a knob. The knob describes an arc as the cam driver is rotated about the axis of rotation. The cam driver is configured to engage one of the engagement slots when the cam is in a dwell position and to rotate the cam to another dwell position as the cam driver assembly is rotated about its axis of rotation. The cam driver assembly also includes a stabilizing member which is configured to engage one of the stabilizing portions of the cam when the cam is in a dwell position.

U.S. Pat. No. 6,295,882 entitled “Device for Operating Display Members at Signs” issued Oct. 2, 2001 having for named inventor Jonas O. Osterberg discloses a device for operating display members at signs for consecutive, repeated presentation of series of images, wherein the members are operated by a driving gear wheel on a drive shaft through a driven gear wheel for each member. The drive shaft has a lock cooperating with a member being non-rotatably connected with the driven gear wheel for setting in a locking position for blocking the driven gear wheel against rotation when no engagement between the gear wheels is present, and leaving its locking position for permitting rotation of the driven gear wheel before engagement once again is present. The lock comprises a first lock member which in locking position cooperates with one of the side surfaces on the non-rotatable member for blocking the driven gear wheel against rotation and preventing displacement of the gear wheels relative to each other in one direction along the longitudinal direction of the drive shaft, and at least one second lock member for at least preventing displacement of the gear wheels relative to each other in at lest the opposite direction along the longitudinal direction of the drive shaft.

U.S. Patent Application Publication No. 20070199216 entitled “Gear Alignment and Slip Assembly for Transmission System of Multi-faced Signs and Billboards” published Aug. 30, 2007 (claiming a priority of PCT patent application Serial No. PCT/US04/28898, filed Sep. 3, 2004, which claims a priority of which claimed the priority of U.S. patent application Ser. No. 60/500,411, filed Sep. 5, 2003) discloses a sign that includes a gear subassembly and a slip assembly operatively associated between the drive shaft and the output shaft of one of the display elements. During a portion of a rotation of the input gear element, the input gear teeth engage the output gear teeth. During another portion, the input gear teeth disengage. At least one partial gear tooth assists in periodically aligning the gear teeth. The slip subassembly comprises: an input slip element defining a generally arcuate line about the axis of the input slip element; and an output slip element defining a generally straight line that is non-intersecting with and extends perpendicular to the input slip axis. During a portion of a rotation of the input slip element, the arcuate line and the straight line of the slip elements are in slipping contact to prevent the output slip element from rotating. During another portion of the rotation, the output slip can be rotated. The slip subassembly has a radius at least a large as the radius of the gear teeth. U.S. Patent Application Publication No. 20070199216 is incorporated herein by reference in its entirety.

As can be seen from the range of different efforts disclosed in these patents of the prior art, there has been a long-felt need for improved indexing systems, especially for multi-faced signs. While each of these prior art patents expands the prior art and may provide certain advantages and benefits, the number of recent patents demonstrates the continued long-felt need for a reliable and cost-effective solution to the maintenance issues associated with the drive and gear systems for multi-faced signs. While several of the prior patents describe certain useful design elements, the prior art still does not adequately solve the problem.

### SUMMARY OF THE INVENTION

According to one aspect of the invention, an indexing drive device for periodic stopping and starting of a rotating output is provided. The indexing drive device includes: (a) a driven cog, wherein the driven cog comprises: (i) a plurality of outer surfaces equally spaced around a periphery of the driven cog; and (ii) a plurality of driven lobes equally spaced around the driven cog; (b) a driving cog adapted to be cooperatively positioned to engage with the driven cog, wherein the driving cog comprises: (i) at least two driving lobes, whereby the driving lobes on the driving cog engage the driven lobes of the driven cog during a turning cycle of the driven cog; and (ii) a semi-circular disc that mates with one of the outer surfaces during a dwell cycle of the driven cog that holds the driven cog in a fixed position during the dwell cycle, wherein the disc has a blank section in the region of the driving lobes to allow the driven cog to turn during a turning cycle of the driven cog.

According to another aspect of the invention, a sign assembly is provided. The sign assembly includes: (A) a frame; (B) a drive shaft rotationally supported by the frame; (C) a drive motor operatively connected to rotationally drive the drive shaft; (D) a plurality of display elements supported by the frame in a row, (E) an output shaft operatively associated with each of the display elements, and (F) a means for periodic stopping and starting of a rotating output, wherein a partial rotation is imparted to each output shaft with one full rotation of the drive shaft. Preferably, the means for periodic stopping and starting of a rotating output is an indexing drive device according to the present invention.

According to another aspect of the invention, a method of periodic stopping and starting of a rotating output is provided. The method includes the steps of: (A) operatively positioning a driving cog to engage a driven cog, (a) wherein the driven cog comprises: (i) a plurality of outer surfaces equally spaced around a periphery of the driven cog; and (ii) a plurality of driven lobes equally spaced around the driven cog; and (b) wherein the driving cog comprises: (i) at least two driving lobes, whereby the driving lobes on the driving cog engage the lobes of the driven cog during a turning cycle of the driven cog; and (ii) a semi-circular disc that mates with one of the outer surfaces during a dwell cycle of the driven cog that holds the driven cog in a fixed position during the dwell cycle, wherein the disc has a blank section in the region of the driving lobes to allow the driven cog to turn during a turning cycle of the driven cog; and (B) rotationally driving the driving cog to periodically stop and start the rotating output of the driven cog.

These and other aspects and advantages of the invention will become apparent to persons skilled in the art from the following drawings and detailed description of presently most-preferred embodiments of the invention.

### BRIEF DESCRIPTION OF THE DRAWING

The accompanying views of the drawing are incorporated into and form a part of the specification to illustrate several aspects and examples of the present invention, wherein like reference numbers refer to like parts throughout the figures of the drawing. These figures together with the description serve to explain the general principles of the invention. The figures are only for the purpose of illustrating preferred and alternative examples of how the various aspects of the invention can be made and used and are not to be construed as limiting the invention to only the illustrated and described examples. The various advantages and features of the various aspects of the present invention will be apparent from a consideration of the drawings.

FIG. 1 is a perspective view of a billboard sign in a typical vertical orientation to the ground, the sign having a frame, a plurality of multi-faced display elements rotationally supported in the frame, a drive motor, and an indexing drive system for periodically rotating the display elements.

FIG. 2 is an exploded perspective of an example of the major parts of one type of a prismatic display element having three planar display surfaces, which is rotationally supported by a lower end cap and an upper bushing.

FIG. 3 is an exploded perspective of an example of the major parts of another type of a prismatic display element having three mounting structures adapted for receiving and supporting changeable display panels (not shown in FIG. 3), which is rotationally supported by a lower end cap and an upper bushing.

FIG. 4 is a perspective view illustrating a changeable face panel being mounted to or removed from the prismatic body of the type of display element shown in FIG. 3.

FIG. 5 is a perspective view of the drive motor and the indexing drive system for a billboard sign having a plurality of indexing drive devices according to the invention, wherein the indexing drive system rotates the prismatic display elements in a wave-like manner.

FIGS. 6a-6e are orthographic projection views of the front, left side, right side, bottom, and top, respectively, of a presently most-preferred embodiment of a plurality of indexing drive devices, each comprising a driving cog and a driven cog, in an example of an operative position for indexing a plurality of multi-faced display elements.

FIG. 7 is a perspective view of an embodiment of a driving cog according to the present invention operatively mounted on a round drive shaft.

FIGS. 8a-8b are perspective views of an embodiment of a driving cog according to the present invention adapted to be operatively mounted on a hexagonal drive shaft.

FIG. 9 is a view of an embodiment of a driving cog according to the present invention that is made of two pieces.

FIGS. 10a-10d are views illustrating that the driven cog can be made with a center bore and keyway (as shown in FIG. 10c) for conventional mounting to a round shaft, it can be made with a hex bore (as shown in FIGS. 10a and 10b) to mount to a hex shaft, or it can be made with an output shaft integrally molded into the driven cog (as shown in FIG. 10d).

FIGS. 11a-11b contrast the advantages of a double node cog according to the present invention (FIG. 11a) relative to a single finger cam device according to the prior art (FIGS. 11b and 11c).

FIG. 12 is a graphical representation of the velocity profile of a single finger cam.

FIG. 13 is graphical representation of the velocity profile of a double node (or lobe) cog according to the invention.

FIG. 14 is an illustration of a twisted hex shaft to create a desirable wave effect for a sign according to the invention.

FIGS. 15a-15b illustrate the advantages of a double lobe cog over a single lobe cog, where FIG. 15a shows that a single cog or lobe on a driving cog has an engagement force that is perpendicular to the axis of rotation, and where FIG. 15b shows that providing a second cog or lobe on a driving cog has the benefit that, as rotation occurs, the contact points with the driven lobes on the driven cog remain perpendicular to the driven axis.

### DETAILED DESCRIPTION OF THE PRESENTLY MOST-PREFERRED EMBODIMENT AND BEST MODE

As used herein, the word “billboard” refers to a large sign, typically a large format sign for outdoors. The preferred embodiments of various aspects of this invention are particularly adapted to be able to be used in “large format” outdoor billboard displays. For example, our present expectation is that this design will work well in a large format sign up to a typical size used in the United States of fourteen (14) feet tall and forty-eight (48) feet long, and preferably in a sign substantially larger than that.

It is to be understood that, unless expressly noted, relational terms such as “vertical”, “horizontal”, “bottom”, “top”, “lower”, “upper”, “front”, “back”, “side”, “left”, “right”, “clockwise”, “counter-clockwise”, etc. are arbitrarily assigned for convenient reference to the orientation and perspective of the figures of the drawing. Furthermore, it is to be understood that relative terms such as “length”, “width”, “height”, etc. are also arbitrarily assigned for convenient reference to the orientation and perspective of the figures of the drawing. For the sake of consistency of usage, once a term is first arbitrarily assigned for reference to a structure in a particular figure, the term will then be used consistently to refer to like parts throughout the other figures of the drawing, even if the orientation of a structure shown in another figure is different for the purpose of showing another feature of the preferred embodiment(s) of the invention. It is to be understood that, unless the context otherwise requires, the use of such arbitrarily-assigned relational or relative terms is not to be construed as unnecessarily limiting the invention.

As used herein and in the claims, the words “comprises” and “includes” are each intended to have an open, non-limiting meaning that does not exclude additional elements or parts of an assembly, subassembly, or structural element.

It should also be understood that the function of a single structure described herein can sometimes be performed by more than one part, or the functions of two different structures can be performed by a single or integrally-formed part. Especially from a manufacturing perspective, it is highly preferred to design the storage device to minimize the total number of parts required to manufacture the storage device. It is not only the costs associated with making additional parts, but also the costs of assembly. Preferably, the fewest possible number of steps and manipulations required to assemble the apparatus, the better. The same reference numeral is used for the same or similar elements throughout the figures of the drawing.

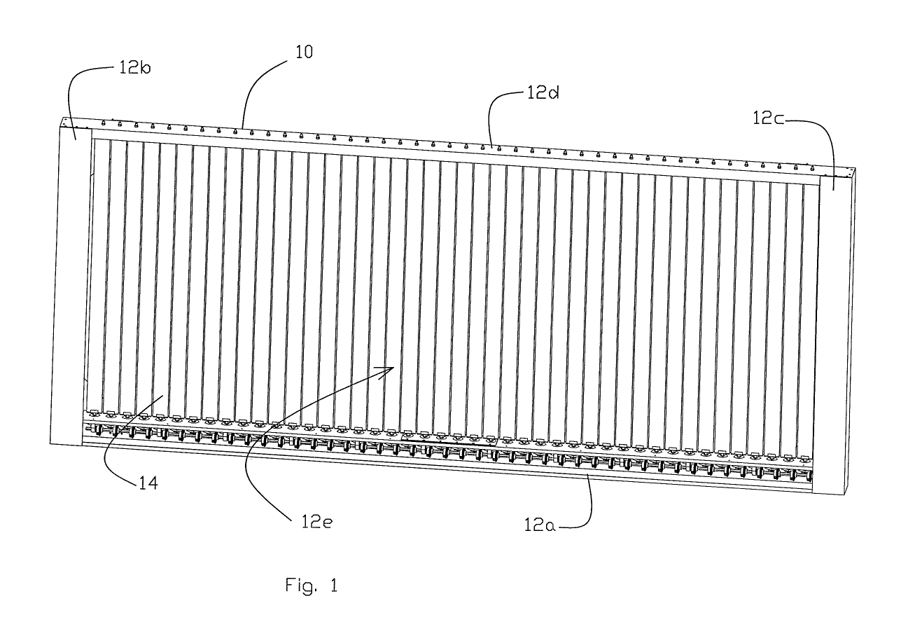

Referring now to the drawing, FIG. 1 is a perspective view of a billboard sign 10. The sign 10 has a frame 12, preferably including a bottom 12a, sides 12b and 12c, and top 12d. The frame 12 defines a window 12e in the front of the sign. A plurality of display elements 14 are supported by the frame 12 in a row, where each of the display elements 14: (i) defines a plurality of display faces (only one of which is shown in FIG. 1); and (ii) is rotationally supported adjacent another one of the display elements; where the plurality of display elements can be selectively rotated to align one display face of each of the display elements in a co-planar relationship to form a substantially planar display, whereby the plurality of display elements can selectively display one of a plurality of displays (not illustrated) in the window 12e. The sign 10 is shown with the display elements 14 in a typical vertical orientation to the ground, but it is to be understood that the display elements could be horizontally or otherwise oriented as desired.

The sign 10 includes a drive motor (not visible in FIG. 1) supported by the frame 12. As will hereinafter be described and illustrated in detail, an indexing drive system (not visible in FIG. 1) for periodically rotating the display elements 14 is enclosed in the frame 12, preferably in the bottom 12a of the frame 12.

Preferably each of the display elements 14 is a generally triangular prism with three display faces. Each of the display elements is rotated 120 degrees to display a different display face. It is to be understood, of course, that the display elements can have only two faces or four or more display faces. As hereinafter described in detail, each display face can be a surface for painting or gluing the strips of an image to be displayed. More preferably, each of the display elements is capable of supporting a changeable display panel at each of the plurality of faces.

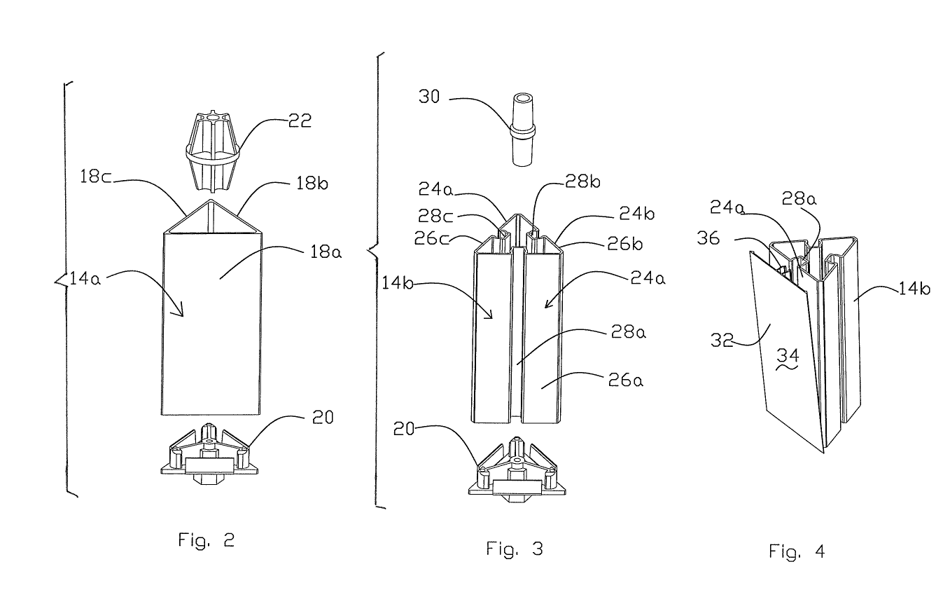

FIG. 2 is an exploded perspective of an example of the major parts of one type of a prismatic display element 14a. This type of display element 14a is a prismatic display element having three planar display surfaces 18a, 18b, and 18c. The display element 14a is rotationally supported by a lower end cap 20 and an upper bushing 22, in a manner well known to those skilled in the art. A strip portion of a printed image to be displayed on the sign may be glued or otherwise secured to one of the display surfaces 18a, 18b, and 18c, in a manner well known to those skilled in the art. Either the display elements 14a must be completely removed and taken to a remote site for applying new images or the new images must be applied to the display elements at the site of the sign.

FIG. 3 is an exploded perspective of an example of the major parts of another type of a prismatic display element 14b. This type of display element 14b is generally in the shape of a triangular prism, but, instead of having display surfaces, has three mounting structures 24a, 24b, and 24c adapted for receiving and supporting changeable display panels (not shown in FIG. 3, but which will be described in detail with reference to FIG. 4.) Each of the mounting structures 24a, 24b, and 24c preferably comprises a support backing 26a, 26b, and 26c, respectively, and a snap-in groove 28a, 28b, and 28c, respectively. Continuing to refer now to FIG. 3, the display element 14b is rotationally supported by a lower end cap 20 and an upper bushing 30, in a manner well known to those skilled in the art.

FIG. 4 is a perspective view of a display element of the type shown in FIG. 3 illustrating a changeable face panel 32 in the process of being mounted to or removed from one of the mounting structures 24a of the prismatic display element 14b. The changeable face panel 32 provides a display face 34 and has a rib 36 extending longitudinally along its back for engaging the snap-in groove of the mounting structure 24a. This allows the strips of a printed sign image to be remotely applied to the display faces 34 of a plurality of changeable face panels 32, then brought to the site of the sign, a plurality of old changeable display panels to be quickly removed from the prismatic display element 14b of the sign, and then the different plurality of changeable display panels 32 can be quickly and easily snapped into place on the display elements 14b, in a manner well known to those skilled in the art. The changeable face panel 32 preferably is substantially made of rigid PVC plastic.

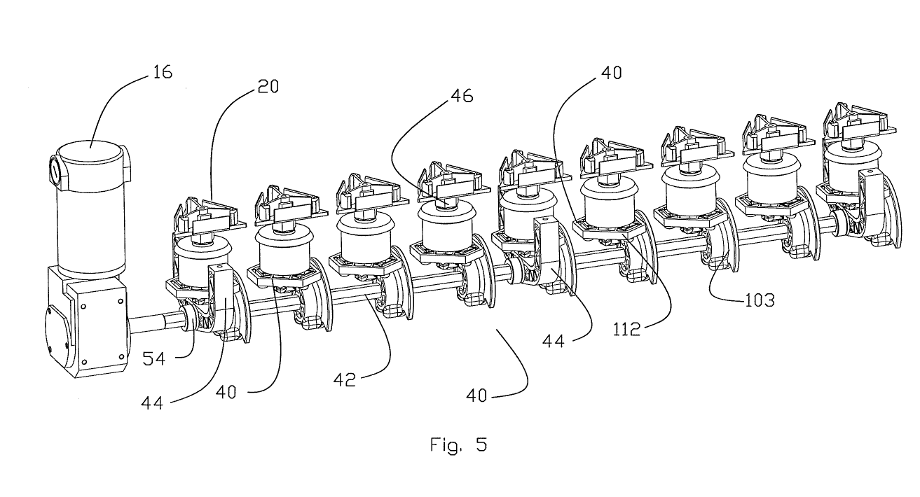

FIG. 5 is a perspective view of the drive motor 16 and an indexing drive system 40 for sign. As previously mentioned, the side frame 12b preferably houses the drive motor 16, and the bottom frame 12a preferably houses the indexing drive system 40. As explained in detail, the indexing drive system 40 rotates the prismatic display elements (not shown in FIG. 5), preferably in a wave-like manner.

The indexing drive system 40 includes a drive shaft 42, which is rotationally supported in the bottom frame 12a by a plurality of horse shoe pillow block bearings 44, where the drive shaft 42 defines a drive shaft rotational axis.

The drive shaft 42 is preferably multi-sided, and most preferably the drive shaft 42 is hexagonal. The drive motor 16 is operatively connected to rotationally drive the drive shaft 42. Preferably, the drive shaft 42 is directly connected to the drive motor 16. Preferably, the drive shaft rotational axis is oriented substantially horizontal to the ground.

The indexing drive system 40 also includes an output shaft 46 operatively associated with each of the display elements 14 (not shown in FIG. 5), preferably through the lower end cap 20 of each of the display elements (which was previously described with reference to FIGS. 2 and 3). The output shaft 46 of each of the display elements: (i) is operatively connected to rotate an associated one of the plurality of display elements; (ii) defines an output shaft rotational axis; and (iii) has its output shaft in non-parallel relationship to the drive shaft. Preferably, the output shaft 46 is multi-sided, and most preferably the output shaft 46 is hexagonal. Preferably, the output shaft 46 is directly connected to the display element at the lower end cap 20. Preferably, a projection of the output shaft rotational axis intersects the drive shaft rotational axis. Most preferably, the output shaft rotational axis and the drive shaft rotational axis are perpendicular. Typically, the output shaft rotational axis is also oriented substantially vertical to the ground.

As will be hereinafter described in detail, the indexing drive system 40 includes a plurality of indexing drive devices 100 for transferring rotational motion from the drive shaft 42 and to each of the output shafts 46. Each indexing drive device 100 preferably comprises a driven cog 112 and a driving cog 103. As will be appreciated, FIG. 5 illustrates an embodiment of the invention where all of the indexing drive devices 100 of the indexing system 40 are aligned to simultaneously rotate the output shafts 46 for the display elements.

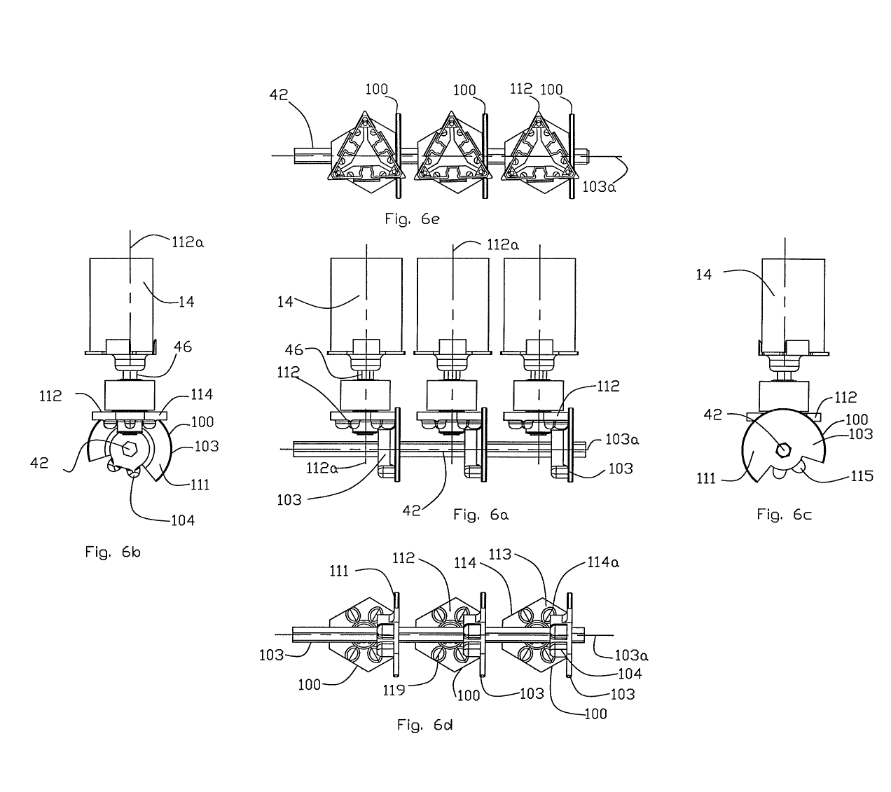

Referring to FIGS. 6a-6e, each indexing drive device 100 delivers partial rotation of an output shaft 46 with one full rotation of a drive shaft 42. Each indexing drive device 100 comprises a driven cog 112 and a driving cog 103. Three of the indexing drive devices 100 are illustrated in the views of FIGS. 6a-6e.

The indexing drive device 100 can be used also for any device that requires periodic precise stopping and starting of a rotating output device, tool, or assembly. According to an aspect of the present invention, this device 100 can be used for repeated consecutive alignment of elongated prismatic louver 14 display members of a sign. For example, the driving cog 103 is operatively connected to a drive shaft 42 of sign and the driven cog 112 is operatively connected to an output shaft 46 of a sign.

As shown in FIG. 6d, for example, according to a presently most-preferred embodiment, the indexing drive device 100 includes: (a) a driven cog 112, wherein the driven cog 112 comprises: (i) a plurality of outer surfaces 114 equally spaced around a periphery 114a of the driven cog 112; and (ii) a plurality of driven lobes 119 equally spaced around the driven cog 112; (b) a driving cog 103 adapted to be cooperatively positioned to engage with the driven cog 112, wherein the driving cog 103 comprises: (i) at least two driving lobes 104, whereby the driving lobes 104 on the driving cog 103 engage the driven lobes 119 of the driven cog 112 during a turning cycle of the driven cog 112; and (ii) a semi-circular disc 111 that mates with one of the outer surfaces during a dwell cycle of the driven cog 112 that holds the driven cog 112 in a fixed position during the dwell cycle, wherein the disc 111 has a blank section 115 in the region of the driving lobes 104 to allow the driven cog 112 to turn during a turning cycle of the driven cog 112.

Preferably, as shown in FIGS. 6a-6e, the rotational axis 112a of the driven cog 112 and the rotational axis 103a of the driving cog 103 are perpendicular.

As best shown in FIGS. 15a and 15b, the driven cog 112 has driven lobes 119 equally spaced around the bottom base portion 113 of the driven cog 112. The driving lobes 104 on the driving cog 103 engage these driven lobes 119 during the turning cycle. Each of the driven lobes 119 projects from the driven cog 112 in parallel to the rotational axis 112a of the driven cog 112. Each of the driven lobes 119 is elongated radially relative to the rotational axis 112a of the driven cog 112. Each of the driven lobes 119 presents a convex curved shape 119a facing one of the rotational directions 112b around the rotational axis 112a of the driven cog 112. Preferably, the convex curved shape is a section of a sphere. More preferably, each of the driven lobes 119 presents at least two convex curved shapes 119a and 119b, each of the two convex curved shapes respectively facing each of the rotational directions around the rotational axis of the driven cog 112. Preferably, each of the two convex curved shapes 119a and 119b respectively facing each of the rotational directions around the rotational axis of the driven cog 112 is a section of a sphere.

The driven cog 112 consists of a six-sided hexagon-like base portion 113 with outer flat surfaces 114 that mate with the semi-circular disc 111 of the driving cog 103 during the dwell cycle. This concept of using a semi-circular disk on an indexing driving device to hold a driven member stationary has been demonstrated in prior art. Preferably, each of the equally-spaced outer surfaces 114 of the driven cog 112 is a continuous flat surface. Each of the equally-spaced outer surfaces 114 is in a tangent plane to a conical shape defined by a radius around the rotational axis 112a of the driven cog 112. The spacing of the equally-spaced outer flat surfaces 114 is defined by the circumferential spacing of the points of tangency for the equally-spaced outer surfaces around the rotational axis of the driven cog 112. The plurality of the equally-spaced outer surfaces partially define an irregular polygon as a peripheral shape of the driven cog 112.

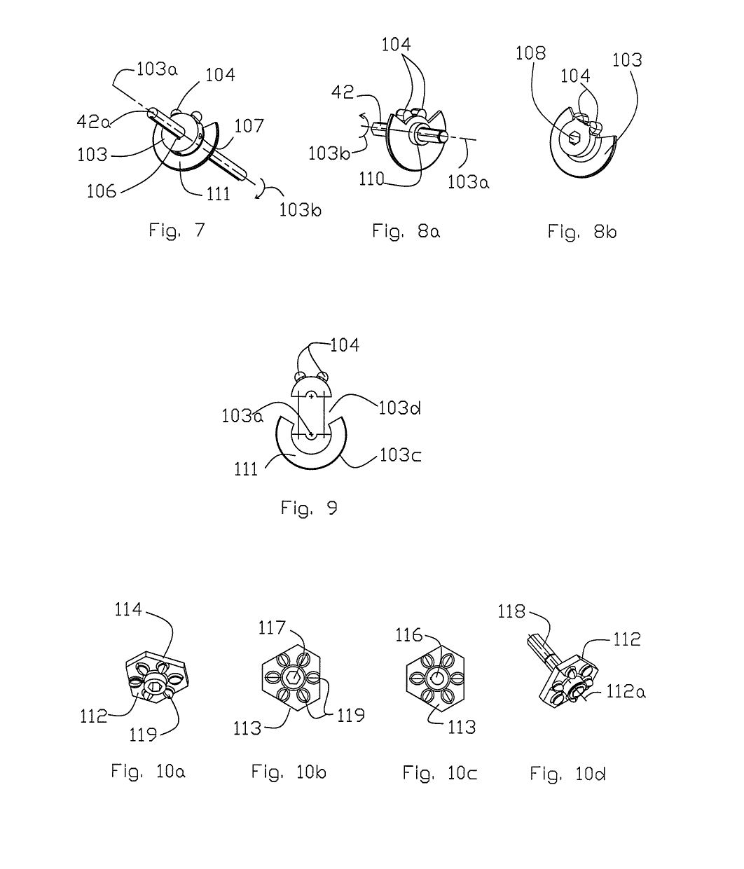

As best shown in FIGS. 7 and 8a-8b, the driving cog 103 is provided having two heavy-duty elongated driving lobes 104. Each of the driving lobes 104 projects in parallel to the rotational axis 103a of the driving cog 103. Each of the driving lobes 104 is elongated in parallel relative to the rotational axis 103a of the driving cog 103. As also partially illustrated in FIG. 15b, each of the driving lobes 104 presents a convex curved shape 104a facing one of the rotational directions 103b around the rotational axis 103a of the driving cog 103. Preferably, the convex curved shape is a section of a cylinder. More preferably, each of the driving lobes 104 presents at least two convex curved shapes respectively facing each of the rotational directions around the rotational axis of the driving cog. Further, each of the two convex curved shapes respectively facing each of the rotational directions around the rotational axis of the driving cog 103 is a section of a cylinder. As best shown in FIG. 15b, most preferably, each of the driving lobes 104 has a substantially semi-cylindrical shape with a rounded end 104b.

The driving cog 103 includes a semi-circular disc 111 that holds the driven cog 112 in a fixed position during the dwell cycle. This semi-circular disc 111 has a blank section or removed section 115 in the region of the driving lobes 104 to allow the driven cog 112 to turn during the turning cycle.

The number of driving lobes 104 on the driving cog 103 and the number of the driven lobes 119 on the driven cog 112 can be varied to change the amount of rotation that is imparted to the driven cog 112 and an output shaft 46. The current figures, e.g., FIGS. 7, 8a-8b, 10a-10d, and 15b, show two driving lobes 104 on the driving cog 103 and six driven lobes 119 on the driven cog 112. This will impart 120 degrees of rotation to the driven cog 112. If a similar driven cog had eight lobes, then the driving cog 103 would impart 90 degrees of rotation to the driven cog. If a similar driving cog had three lobes and the driven cog had six lobes, then 180 degrees of rotation would be seen. The base of a driven cog would contain eight sides for 90-degree rotation and four sides for 120-degree rotation. This invention is not limited to the number of lobes represented in the drawings or the rotational output of the system.

Preferably, the number of the plurality of driven lobes 119 is two divided by the numerical fraction of the rotation to be imparted to the driven cog 112 for each one full rotation of the driving cog 103. According to the presently most-preferred embodiment of the invention, the number of driving lobes 104 is two. Most preferably, the driven cog 112 and driving cog 103 are adapted to deliver a ⅓ partial rotation to the driven cog 112 with one full rotation of the driving cog 103. Accordingly, the number of the outer surfaces 114 on the driven cog 112 is three; the number of the plurality of driven lobes 119 on the driven cog 112 is a total of six; the number of the driving lobes 104 on the driving cog 103 is two; the semi-circular disk 111 of the driving cog is a ⅔ section of a circular disk shape; and the blank section 115 of the semi-circular disk 111 is a ⅓ section of a circular disk shape.

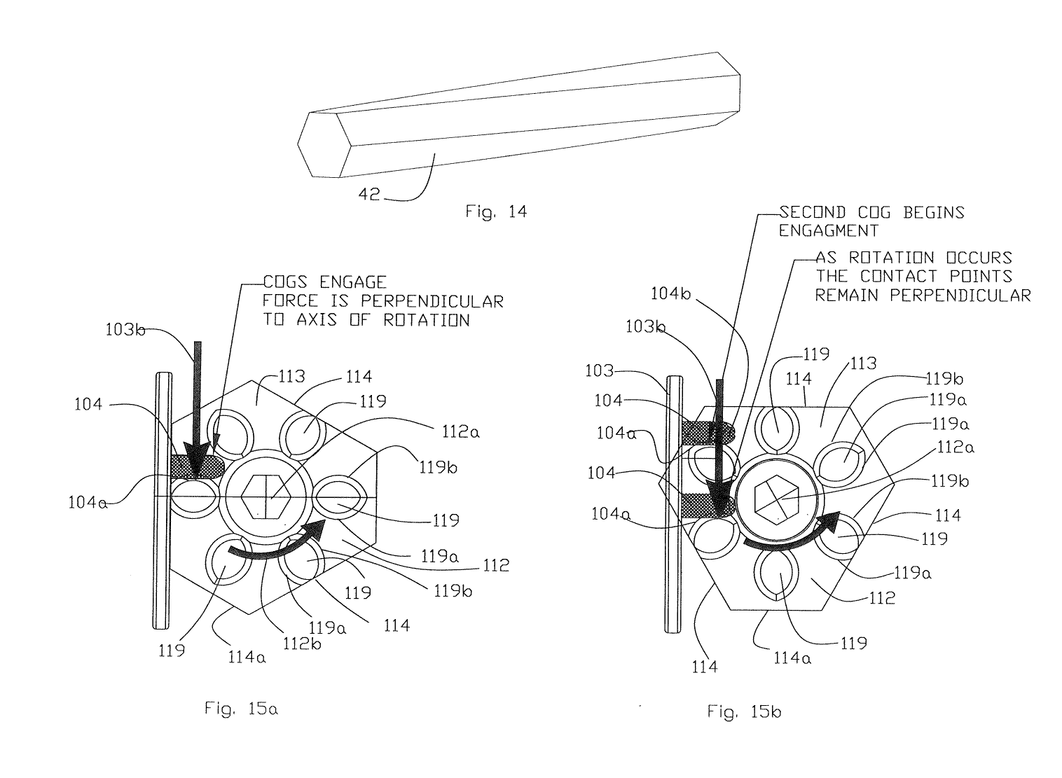

Referring to FIG. 7, the driving cog 103 can be fixed on a round shaft 42a through conventional methods incorporating a keyway 106 and set screw 107. Referring to FIGS. 8a and 8b, according to another, more preferred embodiment of the invention, the driving cog 103 can be manufactured with a hex bore 108 and fixed on a hex shaft 42 with a locking collar 110. If the driving cog 103 is intended to mate with a round shaft 42, it should be made of metal or a metal alloy. Referring to FIG. 9, according to another embodiment of the driving cog 103, the design could be made into two pieces and clamped onto a round shaft or a hex shaft. If the driving cog 103 is mounted on a hex shaft, its physical geometry and strength of design would allow it to be made from low-cost injection molded plastics containing the desired mechanical properties. The hex shaft can be twisted as illustrated in FIG. 14 to create a desirable wave effect as motion is applied to individual prisms incrementally from one end of the sign to another.

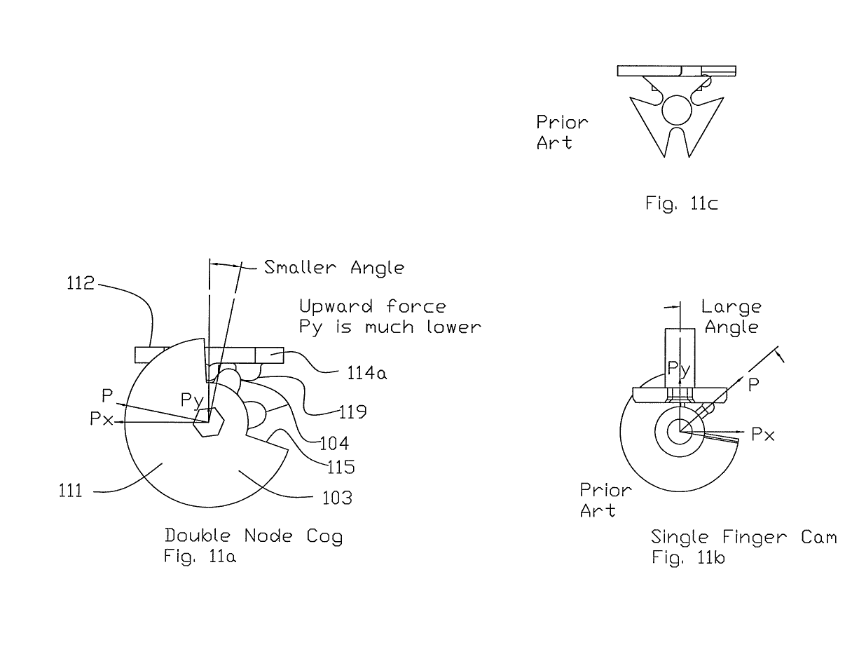

Referring to FIGS. 10a-10d, the driven cog 112 can be made with a center bore and keyway 116 (as shown in FIG. 10c) for conventional mounting to a round shaft, it can be made with a hex bore 117 (as shown in FIGS. 10a and 10b) to mount to a hex shaft, or it can be made with an output shaft 118 integrally molded into the driven cog 112 (as shown in FIG. 10d). This driven cog 112 can be made from casting or molding from suitable plastics or alloys.

Thus, either or both of the output shaft and the drive shaft is a polygonal shaft; and wherein either or both of the central bore of the output shaft and the central bore of the drive shaft is a polygonal bore. The drive shaft is preferably polygonal and axially twisted. Either or both of the driven cog 112 and the driving cog 103 comprises a locking collar. Preferably, the at least two driving lobes are positioned on the locking collar of the driving cog 103.

Referring to FIG. 9, the driving cog 103 can be designed as a two-piece, for example having pieces 103c and 103d. In this configuration, it can be assembled about its rotational axis 103a and removed from a driving shaft without removing the shaft or other components of an indexing drive system (not shown in FIG. 9). This is a benefit for initial assembly labor and maintenance labor when parts have to be replaced. Prior art requires the driving devices to be assembled to the shaft before it is mounted in the drive box. During maintenance, a complete section of shaft has to be removed to replace driving and driven components.

According to another aspect of the invention, a sign assembly is provided. The sign assembly includes: (A) a frame 12; (B) a drive shaft 42 rotationally supported by the frame 12, (C) a drive motor 16 operatively connected to rotationally drive the drive shaft 42; (D) a plurality of display elements 14 supported by the frame 12 in a row, (E) an output shaft 46 operatively associated with each of the display elements 14, and (F) a means for periodic stopping and starting of a rotating output, wherein a partial rotation is imparted to each output shaft with one full rotation of the drive shaft. Preferably, the means for periodic stopping and starting of a rotating output comprises an indexing device 100 according to the present invention. Preferably, each of the display elements 14: (i) defines a plurality of display faces; and (ii) is rotationally supported adjacent another one of the display elements; where the plurality of display elements can be selectively rotated to align one display face of each of the display elements in a co-planar relationship to form a substantially planar display, whereby the plurality of display elements can selectively display one of a plurality of displays. Preferably, the output shaft 46 of each of the display elements 14: (i) is operatively connected to rotate an associated one of the plurality of display elements; and (ii) is in non-parallel relationship to the rotational axis of the drive shaft 42.

According to another aspect of the invention, a method of periodic stopping and starting of a rotating output is provided. The method includes the steps of: (A) operatively positioning a driving cog 103 to engage a driven cog 112, (a) wherein the driven cog 112 comprises: (i) a plurality of outer surfaces 114 equally spaced around a periphery 114a of the driven cog 112; and (ii) a plurality of driven lobes 119 equally spaced around the driven cog 112; and (b) wherein the driving cog 103 comprises: (i) at least two driving lobes 104, whereby the driving lobes 104 on the driving cog 103 engage the driven lobes 119 of the driven cog 112 during a turning cycle of the driven cog; and (ii) a semi-circular disc 111 that mates with one of the outer surfaces 114 during a dwell cycle of the driven cog 112 that holds the driven cog in a fixed position during the dwell cycle, wherein the disc 111 has a blank section 115 in the region of the driving lobes 104 to allow the driven cog 112 to turn during a turning cycle of the driven cog; and (B) rotationally driving the driving cog 103 to periodically stop and start the rotating output of the driven cog 112.

### Differences and Advantages Over the Prior Art

This invention incorporates several design features that make it different compared to prior art. Some of the prior art incorporates a mutilated gear or single finger protrusion to transfer motion from the driving component to the driven component. Gear-type devices transfer force through one or two teeth of the gear during the course of engagement. The finger-type devices of the prior art transfer force through a single extended member. Because of its length, the finger has to sustain shear loads and bending loads that are repetitive. This repetitious strain can lead to premature failure of the extended member.

The load-resisting area of the lobe on the present invention is much greater than existing art using gear technology. Thus, the present invention is stronger, will transfer more force before failure, and wear longer than a gear-type device of similar size and material.

The present invention incorporates elongated (oval) driving lobes of a large cross-sectional area. The lobes on the driven cog consist of radial faces and look similar to a football. The strength and shear capacity of these lobes is substantially larger than that of a gear tooth or that of the extended finger-type driver. The geometry of these parts is such that they are inherently stronger than prior art, and this allows them to be made from materials that are weaker and less expensive than metal. These materials can also be self-lubricating which would contribute to extended life over prior art. This provides a significant cost savings in material and maintenance labor.

Jams can occur in these signs when foreign objects are inserted into them, when mechanical components fail, or when removable graphics wrap around a prism. Prior art uses clutches or current detection and limiting methods to prevent damage to the mechanical components during jam conditions. Each drive component used in a sign with rotating prisms must individually withstand the maximum force imparted to it from the driving motor. If the drive system is limited by weak components, capacity is wasted or the sign will not perform well under moderately adverse conditions. The present invention is stronger than prior art.

Wind can have a major detrimental effect to signs of this type. The torque required to overcome wind forces can be several magnitudes greater than the mechanical resistance in the sign drive train. Some designs incorporate wind meters that shut the sign down because the drive components cannot operate under moderate wind loads. This is undesirable to the advertisers and gives the impression that the sign is malfunctioning. The current invention allows the sign to be driven with more powerful motors that can operate reliably at higher wind loads than a weaker drive mechanism.

Some of the prior art incorporates a single finger-type driver or cam to drive the output cam. The driving cog on the current invention uses two spherical lobes to transfer force to the driven cog. This increases the available surface area subjected to wear and extends the wear characteristics of the mechanism.

Some of the prior art incorporates miter gears or mutilated miter gears to drive the output gear. Miter gears tend to push away from each other during engagement. This thrust force must be countered through a mechanical connection to the input and output shafts. In the present invention, the driver cog lobe meets the driven cog lobe in a position or direction that is perpendicular to the driven axis (FIGS. 15a-15b). This minimizes forces that tend to push the driving cog away from the driven cog. This reduces thrust loads on the drive shaft, driven shaft, and mechanical connections. Minimizing thrust forces increases the reliability of the drive system.

A single finger extension engages the driven device at a greater angle than a double lobe or node on a cog, as shown by comparing the single finger cam illustrated in FIGS. 11b and 11c to the double node or lobe on a cog illustrated in FIG. 11a. The greater this angle, the greater the upward force imparted to the driven component becomes. This acute angle translates into reduced efficiency from higher frictional losses and reduced life of the components due to increased wear. This upward force should be minimized to increase the efficiency of the driving device. The double lobed cog in the present invention minimizes losses due to acute contact angles present in prior art. The double lobe cog's approach angle is 450% less than the single finger cam approach angle.

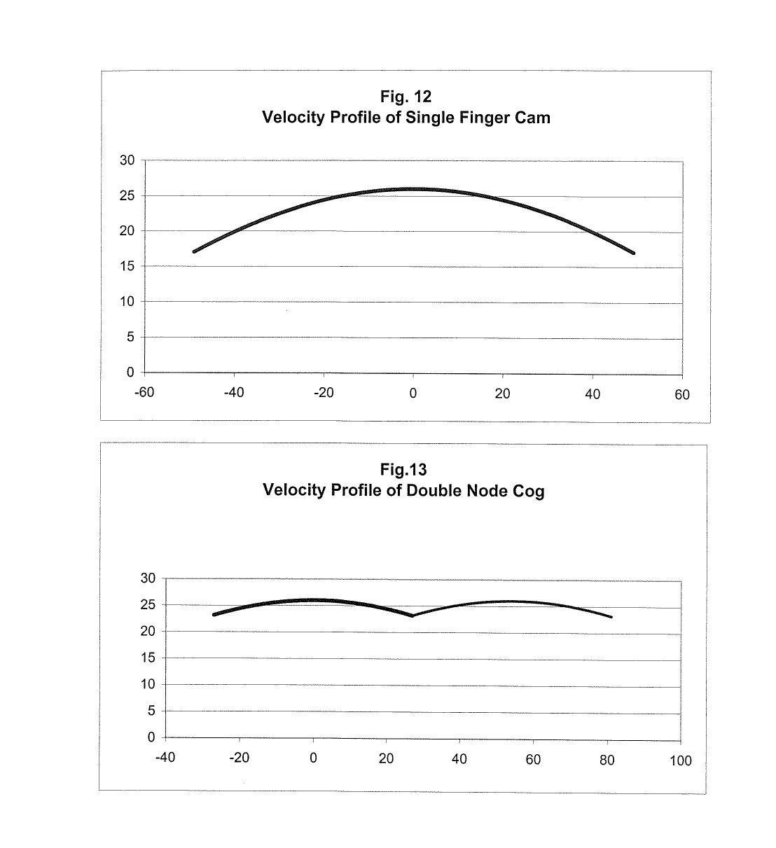

A mutilated gear drive will impart a rotational velocity to the driven gear that is near constant. This means that the shock to the drive system upon engagement of the mutilated gear with the driven gear is at its maximum. It is desirable to start the rotation of the output shaft at a lower value and ramp up to a maximum value and then slow down during the turn cycle. The single finger or cam-type device accomplishes this, but it sacrifices efficiency because of its acute approach angle as discussed previously. FIG. 12 contains a velocity profile for the single finger cam, and FIG. 13 contains a velocity profile for the double lobe cog according to the present invention. The double lobe cog geometry produces two parabolic velocity curves as the two lobes sequentially engage. Thus, the present invention provides the desired acceleration and deceleration without sacrificing efficiency. The drop in speed in the center of the turn as one lobe disengages and the second lobe engages is not perceptible and is considered negligible with respect to the strength and efficiency advantages provided by this design.

Prior art addresses a method of mounting the driving cams or cogs incrementally rotated in order to produce a visually appealing wave affect. This is done by fixing the driving components on the drive shaft at a small angular offset from the previous drive component and repeating this from one end of the drive system to the next. This is typically done during the assembly of the sign. If the angular offset is not uniform from drive to drive, the wave effect will be compromised and not be as visually appealing. In a typical manufacturing environment, it would be difficult to measure or gauge the small angular offsets without some aid. A better way to assure a uniform wave is to use a hex shaft as the drive shaft 42 and impart a permanent twist in the shaft (FIG. 14). Since the cogs are equally spaced on the hex shaft and the twist in the shaft is uniform, the wave effect will be uniform without depending on an assembler to precisely rotate the driving component on the shaft.

The present invention combines simplicity with the previously-stated advantages. Tooling for casting and/or molding of these parts would be less complex than existing art. The parts can be made from injection molded plastics and still maintain a significant strength and cost advantages compared to prior art.

The invention is described with respect to presently-preferred embodiments, but is not intended to be limited to the described embodiments. It will be readily apparent to those of ordinary skill in the art that numerous modifications may be made to the invention without departing from the scope and spirit of the invention as defined by the claims.

What is claimed is:

1. An indexing drive device for periodic stopping and starting of a rotating output, the indexing drive comprising:
(a) a driven cog, wherein the driven cog comprises:
(i) a plurality of outer surfaces equally spaced around a periphery of the driven cog; and
(ii) a plurality of driven lobes equally spaced around the driven cog;
(b) a driving cog adapted to be cooperatively positioned to engage with the driven cog, wherein the driving cog comprises:
(i) at least two driving lobes, whereby the driving lobes on the driving cog engage the driven lobes of the driven cog during a turning cycle of the driven cog; and
(ii) a semi-circular disc that mates with one of the outer surfaces during a dwell cycle of the driven cog that holds the driven cog in a fixed position during the dwell cycle, wherein the disc has a blank section in the region of the driving lobes to allow the driven cog to turn during a turning cycle of the driven cog.

2. The indexing drive device according to claim 1, wherein the rotational axis of the driven cog and the rotational axis of the driving cog are perpendicular.

3. The indexing drive device according to claim 2, wherein each of the driven lobes projects from the driven cog in parallel to the rotational axis of the driven cog.

4. The indexing drive device according to claim 3, wherein each of the driven lobes is elongated radially relative to the rotational axis of the driven cog.

5. The indexing drive device according to claim 3, wherein each of the driven lobes presents a convex curved shape facing one of the rotational directions around the rotational axis of the driven cog.

6. The indexing drive device according to claim 5, wherein the convex curved shape is a section of a sphere.

7. The indexing drive device according to claim 3, wherein each of the driven lobes presents at least two convex curved shapes, each of the two convex curved shapes respectively facing each of the rotational directions around the rotational axis of the driven cog.

8. The indexing drive device according to claim 7, wherein each of the two convex curved shapes respectively facing each of the rotational directions around the rotational axis of the driven cog is a section of a sphere.

9. The indexing drive device according to claim 2, wherein each of the driving lobes projects in parallel to the rotational axis of the driving cog.

10. The indexing drive device according to claim 9, wherein each of the driving lobes is elongated in parallel relative to the rotational axis of the driving cog.

11. The indexing drive device according to claim 9, wherein each of the driving lobes presents a convex curved shape facing one of the rotational directions around the rotational axis of the driving cog.

12. The indexing drive device according to claim 11, wherein the convex curved shape is a section of a cylinder.

13. The indexing drive device according to claim 9, wherein each of the driving lobes presents at least two convex curved shapes respectively facing each of the rotational directions around the rotational axis of the driving cog.

14. The indexing drive device according to claim 13, wherein each of the two convex curved shapes respectively facing each of the rotational directions around the rotational axis of the driving cog is a section of a cylinder.

15. The indexing drive device according to claim 14, wherein each of the driving lobes has a substantially semi-cylindrical shape with a rounded end.

16. The indexing drive device according to claim 2, wherein each of the equally-spaced outer surfaces of the driven cog is a continuous flat surface.

17. The indexing drive device according to claim 16, wherein each of the equally-spaced outer surfaces is in a tangent plane to a conical shape defined by a radius around the rotational axis of the driven cog.

18. The indexing drive according to claim 17, wherein the spacing of the equally-spaced outer flat surfaces is defined by the circumferential spacing of the points of tangency for the equally-spaced outer surfaces around the rotational axis of the driven cog.

19. The indexing drive device according to claim 2, wherein the number of driving lobes is two.

20. The indexing drive device according to claim 2, wherein the driven cog and driving cog are adapted to deliver a ⅓ partial rotation to the driven cog with one full rotation of the driving cog.

21. The indexing drive device according to claim 2, wherein the number of the outer surfaces on the driven cog is three; the number of the plurality of driven lobes on the driven cog is a total of six; the number of the driving lobes on the driving cog is two; the semi-circular disk of the driving cog is a ⅔ section of a circular disk shape; and the blank section of the semi-circular disk is a ⅓ section of a circular disk shape.

22. The indexing drive device according to claim 2, further comprising a plurality of sets of driven cogs and driving cogs.

23. A sign assembly comprising:
(A) a frame;
(B) a drive shaft rotationally supported by the frame;
(C) a drive motor operatively connected to rotationally drive the drive shaft;
(D) a plurality of display elements supported by the frame in a row, where each of the display elements:
(i) defines a plurality of display faces; and
(ii) is rotationally supported adjacent another one of the display elements;
where the plurality of display elements can be selectively rotated to align one display face of each of the display elements in a co-planar relationship to form a substantially planar display, whereby the plurality of display elements can selectively display one of a plurality of displays;
(E) an output shaft operatively associated with each of the display elements, where the output shaft of each of the display elements:
(i) is operatively connected to rotate an associated one of the plurality of display elements; and
(ii) is in non-parallel relationship to the drive shaft; and
(F) a means for periodic stopping and starting of a rotating output, wherein a partial rotation is imparted to each output shaft with one full rotation of the drive shaft.

24. A sign assembly according to claim 23, wherein the means for periodic stopping and starting of a rotating output comprises:
(a) a driven cog, wherein the driven cog comprises:
(i) a plurality of outer surfaces equally spaced around a periphery of the driven cog; and
(ii) a plurality of driven lobes equally spaced around the driven cog; and
(b) a driving cog adapted to be cooperatively positioned to engage with the driven cog, wherein the driving cog comprises:
(i) at least two driving lobes, whereby the driving lobes on the driving cog engage the driven lobes of the driven cog during a turning cycle of the driven cog; and
(ii) a semi-circular disc that mates with one of the outer surfaces during a dwell cycle of the driven cog that holds the driven cog in a fixed position during the dwell cycle, wherein the disc has a blank section in the region of the driving lobes to allow the driven cog to turn during a turning cycle of the driven cog.

25. A method of periodic stopping and starting of a rotating output, the method comprising the steps of:
(A) operatively positioning a driving cog to engage a driven cog,
(a) wherein the driven cog comprises:
(i) a plurality of outer surfaces equally spaced around a periphery of the driven cog; and
(ii) a plurality of driven lobes equally spaced around the driven cog; and
(b) wherein the driving cog comprises:
(i) at least two driving lobes, whereby the driving lobes on the driving cog engage the driven lobes of the driven cog during a turning cycle of the driven cog; and
(ii) a semi-circular disc that mates with one of the outer surfaces during a dwell cycle of the driven cog that holds the driven cog in a fixed position during the dwell cycle, wherein the disc has a blank section in the region of the driving lobes to allow the driven cog to turn during a turning cycle of the driven cog; and
(B) rotationally driving the driving cog.
